(19) United States
(12) Patent Application Publication
(10) Pub. No.: US 2025/0095396 A1
(43) Pub. Date: Mar. 20, 2025

(54) DOCUMENT ANALYSIS AND EXTRACTION FOR VERIFICATION EVENTS

(71) Applicant: Capital One Services, LLC, McLean, VA (US)

(72) Inventors: Narasimha Rao YALAMALA, Little Elm, TX (US); Rahul RAJ, Irving, TX (US); Soma Sekhar TANKALA, Frisco, TX (US); Sai Pradeep KURAKULA, Allen, TX (US)

(21) Appl. No.: 18/468,988

(22) Filed: Sep. 18, 2023

(51) Int. Cl. G06V 30/41; G06F 40/295; G06V 30/10

(52) U.S. Cl. CPC G06V 30/41; G06F 40/295; G06V 30/10

(57) ABSTRACT

In some implementations, a device may obtain, via an asynchronous event associated with a data streaming platform, one or more document images associated with an account. The device may detect, based on the asynchronous event, a verification event associated with the account, wherein the verification event is associated with one or more verification parameters. The device may obtain, via one or more document information extraction operations, extracted information from the one or more document images. The device may communicate, with one or more data sources, to obtain verification information that is based on the extracted information. The device may determine, based on the verification information and the one or more verification parameters, feedback information associated with the account. The device may transmit, via the data streaming platform, the feedback information based on obtaining the one or more document images.

### BACKGROUND

Document analysis techniques may include optical character recognition (OCR) techniques, natural language processing (NLP) techniques, computer vision techniques, and/or other image processing techniques. For example, OCR techniques may be used in computing environments to identify text within an image and extract the text in a manner designed to enable the identified text to be read by a human and/or handled by a computer. Digital documents may be stored on a device as an image, rather than machine-encoded text. OCR, NLP, computer vision, and/or other techniques can be used by the device to identify text included in the digital documents so that the digital documents can be electronically processed by the device.

### SUMMARY

Some implementations described herein relate to a system for document analysis and extraction for verification events. The system may include one or more memories and one or more processors communicatively coupled to the one or more memories. The one or more processors may be configured to obtain, via an asynchronous event associated with a data streaming platform, one or more document images associated with an account. The one or more processors may be configured to detect, based on the asynchronous event, a verification event associated with the account, wherein the verification event is associated with one or more verification parameters. The one or more processors may be configured to obtain, via one or more document information extraction operations, extracted information from the one or more document images. The one or more processors may be configured to determine, based on the extracted information and the one or more verification parameters, one or more data sources associated with the verification event. The one or more processors may be configured to communicate, with the one or more data sources, to obtain verification information that is based on the extracted information. The one or more processors may be configured to determine, based on the verification information and the one or more verification parameters, feedback information associated with the account, wherein the feedback information indicates whether any discrepancies exist associated with the one or more document images. The one or more processors may be configured to transmit, via the data streaming platform and based on obtaining the one or more document images, the feedback information.

Some implementations described herein relate to a method for document analysis and extraction for verification events. The method may include obtaining, by a device and via an asynchronous event associated with a data streaming platform, one or more document images associated with an account. The method may include detecting, by the device and based on the asynchronous event, a verification event associated with the account, wherein the verification event is associated with one or more verification parameters. The method may include obtaining, by the device and via one or more document information extraction operations, extracted information from the one or more document images. The method may include communicating, by the device and with one or more data sources, to obtain verification information that is based on the extracted information, wherein the one or more data sources are based on the extracted information. The method may include determining, by the device and based on the verification information and the one or more verification parameters, feedback information associated with the account, wherein the feedback information indicates whether any discrepancies exist associated with the one or more document images. The method may include transmitting, by the device and via the data streaming platform, the feedback information based on obtaining the one or more document images.

Some implementations described herein relate to a non-transitory computer-readable medium that stores a set of instructions. The set of instructions, when executed by one or more processors of a device, may cause the device to obtain, via an asynchronous event associated with a serverless function, one or more document images associated with an account. The set of instructions, when executed by one or more processors of the device, may cause the device to detect, based on the asynchronous event, a verification event associated with the account, wherein the verification event is associated with one or more verification parameters. The set of instructions, when executed by one or more processors of the device, may cause the device to obtain, via one or more document information extraction operations, extracted information from the one or more document images. The set of instructions, when executed by one or more processors of the device, may cause the device to determine, based on the extracted information and the one or more verification parameters, one or more data sources associated with the verification event. The set of instructions, when executed by one or more processors of the device, may cause the device to communicate, with the one or more data sources, to obtain verification information that is based on the extracted information. The set of instructions, when executed by one or more processors of the device, may cause the device to determine, based on the verification information and the one or more verification parameters, feedback information associated with the account, wherein the feedback information indicates whether any discrepancies exist associated with the one or more document images. The set of instructions, when executed by one or more processors of the device, may cause the device to transmit, based on obtaining the one or more document images, the feedback information.

### BRIEF DESCRIPTION OF THE DRAWINGS

FIGS. 1A-1D are diagrams of an example associated with document analysis and extraction for verification events, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with document analysis and extraction for verification events, in accordance with some embodiments of the present disclosure.

FIG. 4 is a flowchart of an example process associated with document analysis and extraction for verification events, in accordance with some embodiments of the present disclosure.

### DETAILED DESCRIPTION

The following detailed description of example implementations refers to the accompanying drawings. The same reference numbers in different drawings may identify the same or similar elements.

In some examples, a device may obtain many documents that are associated with information to be verified. For example, the documents may be associated with accounts and/or applications. In some examples, the device may automatically process the documents to verify information associated with the documents. However, processing a large volume of documents automatically poses several challenges. For example, ensuring scalability to handle the data volume requires both horizontal and vertical scaling of infrastructure. Existing processing systems may struggle to handle the sheer quantity of data efficiently. Additionally, the documents may be associated with different formats, structures, and/or quality (e.g., image quality), among other examples. Because of the diverse data formats and quality differences, it may be difficult to extract meaningful features from unstructured data.

In some examples, the device may represent information indicated by the document(s) as features for processing. For example, it may be difficult to extract relevant features for verification from unstructured data (e.g., text in a document) and combining them with structured data (like numeric scores). Further, some verification operations require real-time or near-real-time processing, such as for customer service inquiries or fraud detection. Because of the large volume of documents and/or large volume of verification operations to be performed, the device may be unable to handle processing requirements for the verification operations within strict time constraints, resulting in increased latency associated with the verification operations.

In additional to the difficulty associated with identifying and/or extracting relevant features for verification from unstructured data, the device may need to communicate with other systems or devices to verify information associated with the relevant features. Because the document(s) may present data in an unstructured and/or inconsistent manner, the device may be unable to identify a source that is capable of verifying the information associated with the relevant features. For example, the device may be unable to identify a communication channel over which the device can communicate with the source to verify the information associated with the relevant features. As a result, the device may be unable to perform a verification operation (e.g., without user intervention) and/or may consume significant time, processing resources, memory resources, and/or network resources associated with determining one or more communication channels over which the device can communicate with respective sources to verify the information associated with the relevant features.

Some implementations described herein enable document analysis and extraction for verification events. For example, a verification device may obtain, via an asynchronous event associated with a data streaming platform, one or more document images associated with an account. The one or more document images may be images of respective documents associated with the account. The verification device may detect, based on the asynchronous event, a verification event associated with the account. For example, the verification event may be associated with verifying information indicated by the one or more document images. The verification event may be associated with one or more verification parameters. The one or more verification parameters may indicate information (or parameters) to be verified.

The verification device may obtain, via one or more document information extraction operations, extracted information from the one or more document images. The extracted information may be based on the one or more verification parameters. For example, the verification device may analyze the one or more document images to identify information relevant to the one or more verification parameters using the one or more document information extraction operations, such as an optical character recognition (OCR) operation, a natural language processing (NLP) operation, a named entity recognition operation, and/or a text mining operation, among other examples.

The verification device may determine, based on the extracted information and the one or more verification parameters, one or more data sources associated with the verification event. For example, the verification device may analyze the extracted information to identify the one or more data sources. As an example, the verification device may determine categories of data sources based on respective verification parameters from the one or more verification parameters. Using a category of data sources, the verification device may determine, based on the extracted information, one or more data sources associated with the category of data sources that are to be used to verify the extracted information.

In some implementations, the verification device may determine, based on the one or more data sources, one or more communication channels over which the verification device is to communicate to verify the extracted information. The one or more communication channels may include one or more application programming interfaces (APIs), a communication protocol channel, a message queue, a webhook, a file transfer protocol, and/or another communication channel. The verification device may communicate, with the one or more data sources, to obtain verification information that is based on the extracted information. For example, the verification device may communicate with the one or more data sources via respective communication channels.

The verification device may determine, based on the verification information and the one or more verification parameters, feedback information associated with the account. For example, the feedback information may indicate whether any discrepancies exist associated with the one or more document images. The verification device may transmit, via the data streaming platform and based on obtaining the one or more document images, the feedback information.

As a result, the verification device may perform verification of documents (e.g., document images). For example, by using data streaming platforms and serverless architectures, the verification may occur via event-based communication (e.g., the asynchronous event for verification). The event-based communication allows for the immediate detection and processing of changes, such as a verification event. Further, the data streaming platform may decouple data procedures (e.g., associated with the account) from data consumers (e.g., the verification device), enabling more flexible and scalable architectures for the verification process. Further, by combining data streaming platforms with processing functions, such as a serverless function, the verification device may utilize a robust and scalable real-time processing pipeline for verification that is based on extracted information from document images.

Additionally, by using the one or more document information extraction operations, the verification device may be enabled to extract and/or analyze information that is relevant for the verification event from documents that may be associated with different formats, structures, and/or quality (e.g., image quality), among other examples. Further, the one or more document information extraction operations may enable the verification device to extract and/or analyze information from a large quantity of documents for many verification events in a short period of time. As another example, by using the one or more verification parameters indicated by the verification event and the extracted information, the verification device may be enabled to quickly identify data sources and/or communication channels that can be used to verify the extracted information. This may conserve time, processing resources, memory resources, and/or network resources that would have otherwise been used in association with determining one or more communication channels over which the verification device can communicate with respective data sources to verify the information associated with relevant features.

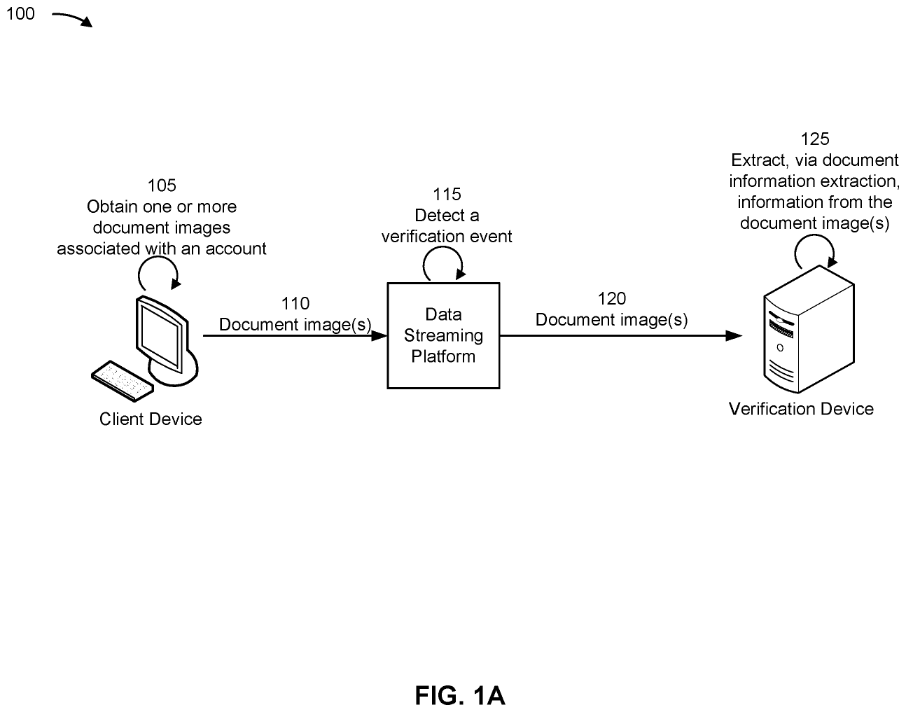

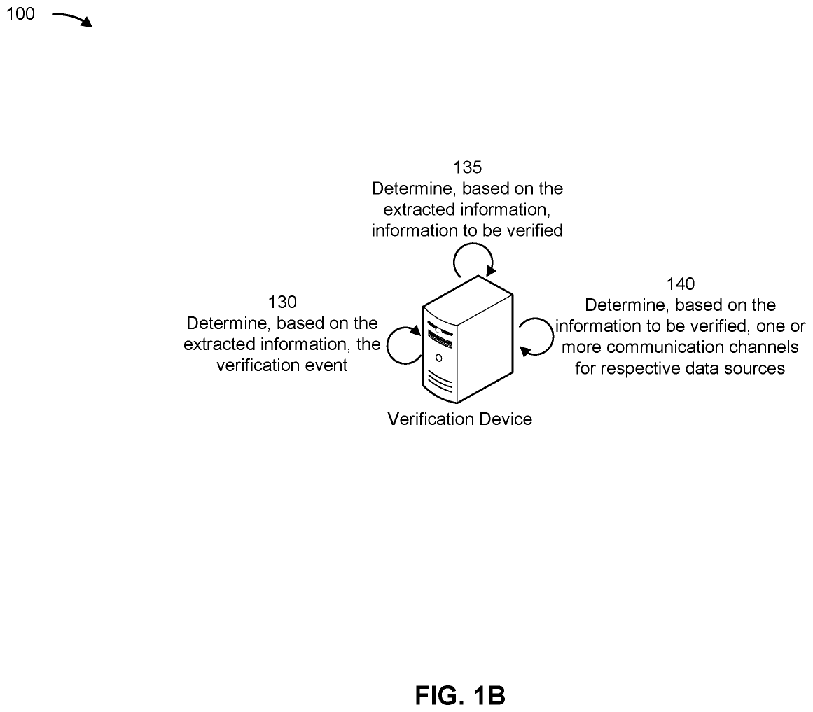

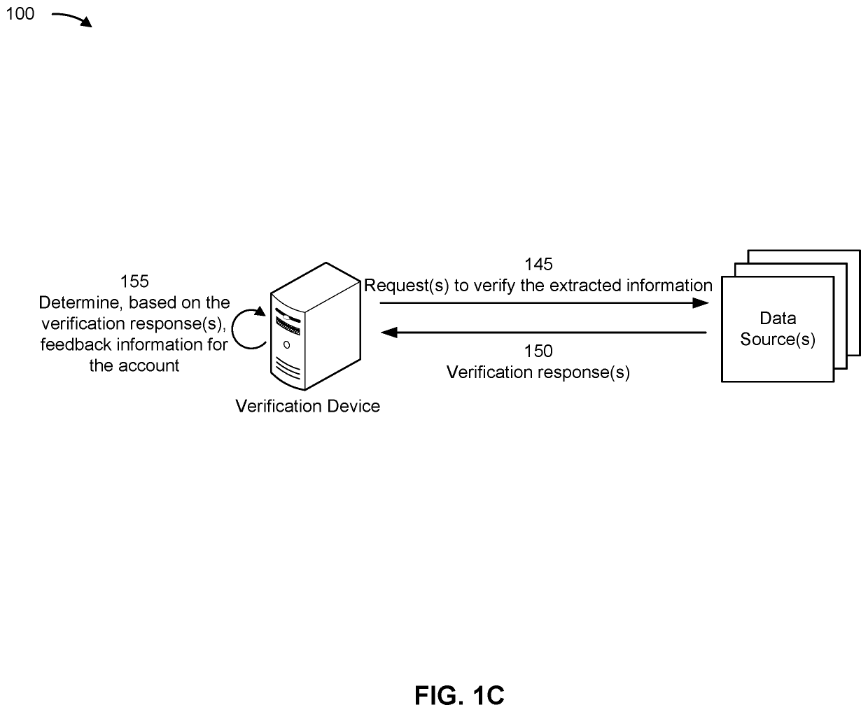

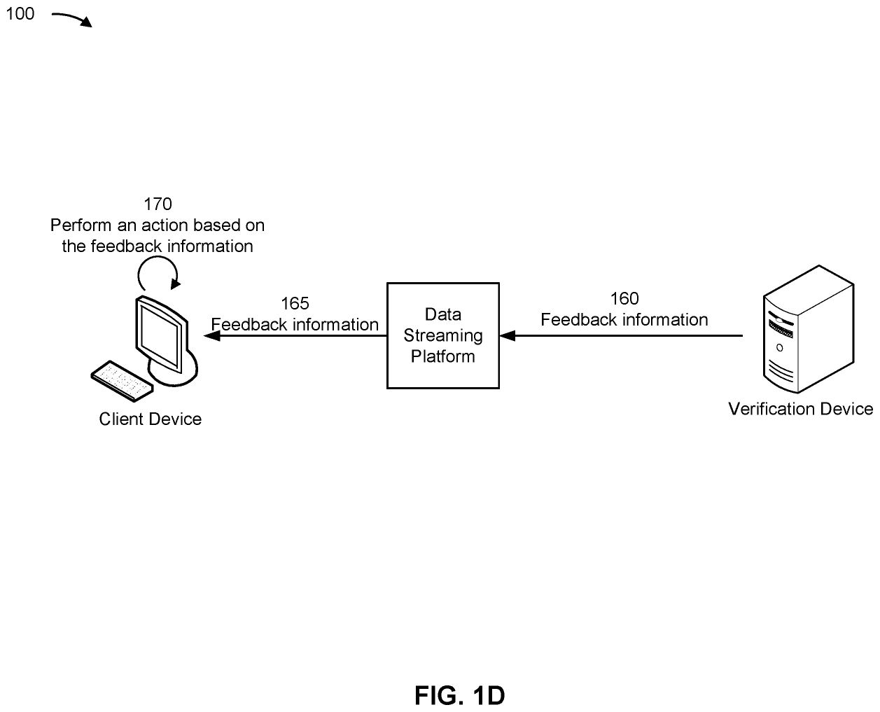

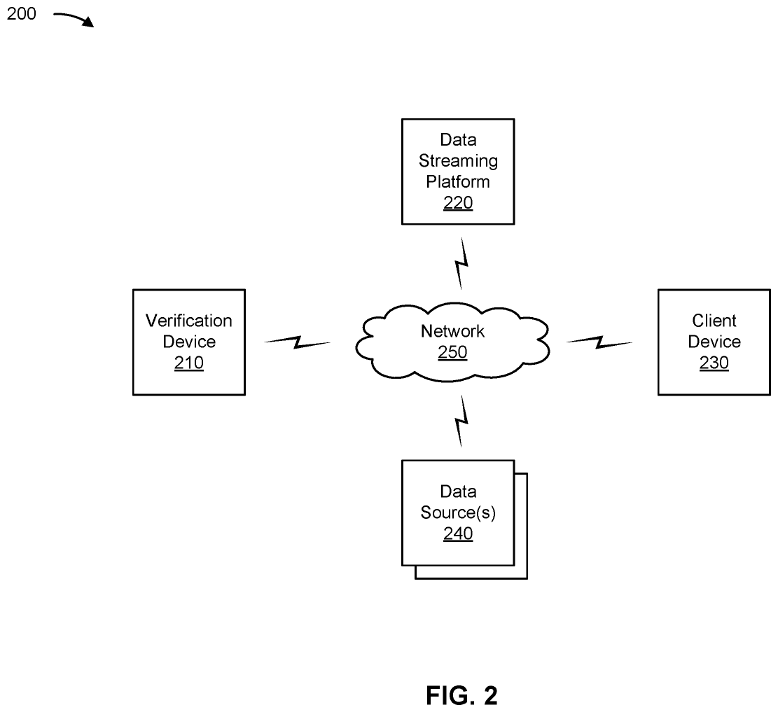

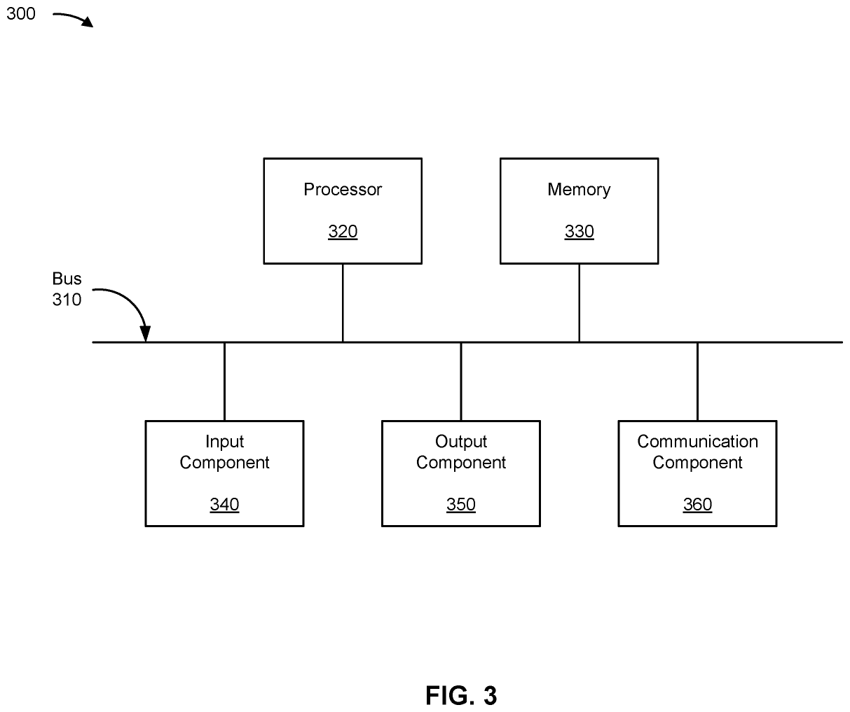

FIGS. 1A-1D are diagrams of an example 100 associated with document analysis and extraction for verification events. As shown in FIGS. 1A-1D, example 100 includes a verification device, a client device, a data streaming platform, and one or more data sources. These devices are described in more detail in connection with FIGS. 2 and 3.

As shown in FIG. 1A, and by reference number 105, the client device may obtain one or more document images associated with an account. A document image may be an image of a document, such as a picture, a portable document format (PDF) file, a digital image, a word processing document, and/or another type of image. For example, the client device may obtain one or more document images as part of an application process associated with the account. For example, a user may provide one or more documents (e.g., application documents) to apply for the account and/or a service associated with the account. As an example, the client device may obtain one or more document images as part of an application for a loan. As another example, the client device may obtain one or more document images as part of another type of application and/or a modification associated with the account.

As shown by reference number 110, the client device may provide, to the data streaming platform, the one or more document images. For example, the client device may display a user interface. A user may interact with the user interface to upload the one or more document images to the data streaming platform. For example, a customer may apply to obtain the account (e.g., may apply to obtain a loan). As part of the application process, the customer may provide one or more documents to support the application. The client device may obtain one or more document images of respective documents associated with the application.

In some implementations, the client device may output an initial determination as to whether to approve or deny the application. For example, the client device may obtain (e.g., via the one or more data sources or other devices) information associated with an application determination. The client device may provide, for display, an indication of the information associated with an application determination and/or an initial determination as to whether to approve or deny the application (e.g., where the initial determination is based on the information associated with an application determination). In such examples, the verification process described herein may include an auditing process of the application determination.

The data streaming platform may be an event-based streaming platform. An event-based streaming platform may be a scalable technology that facilitates the real-time processing, transmission, and/or consumption of events, messages, and/or data streams, among other examples. The data streaming platform may be configured to handle high volumes of data and enable the verification device to react to events as they occur. An event is a discrete piece of data that represents a specific occurrence or change in a system. For example, an event may include a verification event. A verification event may be associated with one or more document images being provided by the client device for verification and/or auditing purposes.

An asynchronous event is a type of event that is processed independently of the main flow of a program or system. Unlike synchronous events, which may be processed immediately and block the execution of other operations until completion, asynchronous events may allow for concurrent processing by the verification device without waiting for each event to be fully processed before moving on to the next event or operation. For example, one or more client devices may generate and send events (e.g., associated with verification processes) asynchronously to the data streaming platform. For example, a given client device may not wait for the event to be consumed or processed by the verification device before continuing an execution of other operations. This decoupling between event production and consumption may enable high throughput and scalability associated with verification operations, enabling the verification device to perform verifications for a high quantity of users and/or applications at the same time. For example, the verification device may read and process events asynchronously as the events become available.

As shown by reference number 115, the data streaming platform and/or the verification device may detect a verification event. For example, the data streaming platform and/or the verification device may detect the verification event based on the one or more document images. For example, the data streaming platform and/or the verification device may detect the verification event based on the one or more document images being provided to the data streaming platform. In some implementations, the data streaming platform and/or the verification device may detect the verification event based on a topic (e.g., a logical channel or category) to which the one or more document images are published via the data streaming platform. For example, the client device may transmit or provide the one or more document images to one or more specific topics. The data streaming platform and/or the verification device may detect the verification event based on the one or more document images being provided to a topic associated with verifications associated with accounts, such as the account.

In some implementations, the data streaming platform may include a serverless framework. The serverless framework may use one or more serverless functions to perform tasks. A serverless function may be code that runs in the cloud computing environment and is executed in response to a specific trigger or event. A serverless function may be referred to interchangeably herein as a lambda function and/or an anonymous function. The serverless function may be stateless, meaning that the serverless function does not retain any data or state between invocations. This allows the serverless function to scale horizontally and be triggered multiple times concurrently without interference.

Additionally, the serverless function may be managed by a cloud provider associated with the cloud computing environment. Therefore, developers (e.g., associated with developing the task or service) may not need to provision or maintain servers or infrastructure associated with performing the task or service. Instead, the developers can simply upload code and configure the triggers and events that will invoke the serverless function, and the cloud provider may handle provisioning resources and infrastructure associated with executing the code via the serverless function. A given serverless function may be referred to as an instance of a serverless function. Serverless functions may be cost effective because the developers may only be charged (e.g., for use by the cloud provider) for the duration of the function execution and will not incur any charges when serverless functions are not running. This makes serverless functions well-suited for applications that require frequent, short-duration executions, such as image or video processing, data stream processing, and/or real-time data analysis, among other examples.

When using a serverless framework, developers may write code that runs in response to specific events, such as a verification event. The cloud provider may be responsible for running and scaling the code, as well as providing the necessary resources and/or infrastructure, such as memory and computing power, among other examples. Because serverless frameworks may only charge for the specific resources and computing time used, a serverless framework can be a cost-effective solution for applications that have unpredictable workloads or experience sudden spikes in traffic (e.g., a cloud provider only charges an entity for the cloud resources actually used). Additionally, serverless frameworks also provide built-in high availability and auto-scaling capabilities, so that a task can automatically scale up or down based on the number of requests associated with the task, which can help ensure that the task is always available and responsive. One example of a serverless framework is the AMAZON WEB SERVICES (AWS®) Lambda framework. For example, the data streaming platform may include a serverless function configured to provide an indication of the verification event and/or the one or more document images to the verification device (e.g., based on the detection of the verification event).

As shown by reference number 120, the verification device may obtain the one or more document images. For example, the verification device may obtain, via the verification event (e.g., an asynchronous event) associated with the data streaming platform, the one or more document images associated with the account. For example, a serverless function of the data streaming platform may be configured to provide, based on detecting the verification event, the one or more document images to the verification device.

In some implementations, the verification device may detect, based on the asynchronous event, the verification event associated with the account. The verification event may be associated with one or more verification parameters. For example, the verification device may identify a topic (e.g., a logical channel or category) via which the one or more document images are obtained. For example, the verification device may subscribe to the topic (e.g., to enable the verification device to obtain indications and/or information associated with events provided via the topic). The data streaming platform may provide the one or more document images to the verification device based on the verification device being subscribed to the topic associated with the verification event.

As shown by reference number 125, the verification device may extract, via one or more document information extraction operations, information from the one or more document images. For example, the verification device may obtain, via one or more document information extraction operations, extracted information from the one or more document images. For example, the one or more document information extraction operations may include an OCR operation, an NLP operation, a computer vision operation, a named entity recognition operation, a text recognition operation, an image processing operation, and/or a text mining operation, among other examples.

The extracted information may include information that is relevant for verification operation(s). For example, the verification device may analyze the document image(s) to determine a location or field in a document where the relevant information may be located. As an example, the extracted information may include a user's name, an address, a phone number, personally identifiable information (e.g., a social security number, a driver's license number, or other personally identifiable information), funding information (e.g., employment information, bank account information, or other information indicating how the owner of the account intends to fund payments associated with the account), credit information (e.g., a credit score), and/or application information (e.g., application date, application terms, a loan amount, an account type or loan type, a loan term, a monthly payment amount, or other application information), among other examples.

For example, the verification device may analyze the one or more document images to identify one or more document characteristics. For example, the verification device may analyze a document image using one or more text recognition operations and/or image processing operations. For example, the verification device may analyze the document using an OCR technique, an NLP technique, a computer vision technique, and/or another image processing or text recognition technique.

For example, in some implementations, the verification device may identify segments in a document image. For example, the verification device may use one or more computer vision techniques to identify edges depicted in the document image. The verification device may use the identified edges to identify the segments within the image data (e.g., each segment being defined by one or more edges forming a rectangular shape). In some implementations, the verification device may identify, from the segments identified in the image data, a segment of interest (e.g., a segment that includes, or is likely to include, text of interest, such as text of a particular type and/or text likely to include information relevant for verification operation(s)). For example, the verification device may identify segments of interest that include, or are likely to include, document characteristics, such as an entity associated with the document, an amount (e.g., a salary, a loan amount, or another amount) associated with the account, funding information, one or more account parameters (e.g., a loan length or term, an interest rate, or another account parameter), application information, a termination date associated with the account, a payment amount associated with a loan, and/or one or more dates associated with a change in terms or available features or services provided via the account, among other examples. In some implementations, a computer vision model or an OCR model may be trained to recognize segments that include, or are likely to include, text of interest.

For example, the verification device may identify different portions of the document image that are likely to include relevant information for the verification operation. For example, a first portion of the document image may include text identifying the entity associated with the document. A second portion of the document image may include text identifying starting data associated with the account (or associated with a service provided via the account). A third portion of the document image may include text identifying an amount of time associated with a loan associated with the account. A fourth portion of the document image may include text identifying a payment amount associated with the loan. A fifth portion of the document may include text identifying a funding source associated with the account (e.g., employment information of the user associated with the account). Other portions of the document image may include text identifying other document characteristics associated with the document. The verification device may use a computer vision technique, an OCR technique, and/or an NLP technique, among other examples, to identify the different portions and to identify and process the text included in the different portions. For example, the verification device may convert the text into a machine-readable form to enable the verification device to understand and identify the document characteristics identified by the text.

Additionally, or alternatively, the verification device may receive, from the client device via the data streaming platform, an indication of the extracted information described herein. For example, a user may input information associated with the document images to the client device (e.g., via an application, user interface, or web page managed by, or associated with, the verification device). The client device may transmit, and the verification device may receive, information included in the extracted information.

As shown in FIG. 1B, and by reference number 130, the verification device may determine, based on the extracted information, the verification event. For example, the verification device may analyze the extracted information to determine a type of verification event. For example, the verification device may determine, based on the extracted information, an application type and/or an account type associated with the one or more document images. The application type and/or the account type may be indicative of the verification event. Additionally, or alternatively, the verification device may determine, based on the extracted information, one or more types or categories of information extracted from the one or more document images. The one or more types or categories of information extracted from the one or more document images may be indicative of the verification event.

In some implementations, the verification device may detect the verification event based on the one or more document images being provided to a topic associated with the verification event. In some implementations, the verification event may indicate one or more operations to be performed by the verification device for verifying information associated with the account and/or application. Additionally, or alternatively, the verification event may indicate one or more types or one or more categories of information to be verified and/or audited by the verification device.

As shown by reference number 135, the verification device may determine, based on the extracted information, information to be verified (e.g., information to be audited for the account and/or the application). For example, the verification device may extract, via the one or more document information extraction operations, one or more verification parameters. A verification parameter may be indicative of information to be verified and/or audited by the verification device. For example, the one or more verification parameters may be associated with information indicated by a document depicted by the one or more document images. The one or more verification parameters may include a requested amount parameter (e.g., a loan amount), one or more user information parameters (e.g., a name parameter, an address parameter, one or more employment parameters, one or more income parameters, and/or one or more funding parameters), and/or one or more application parameters, among other examples.

In some implementations, the verification device may determine, based on the extracted information, a verification type associated with the account and/or the application. As an example, the extracted information may indicate a security item (e.g., collateral) associated with the loan (e.g., for an auto loan, the security item may be a vehicle). The verification device may determine the verification type associated with the account and/or the application based on a type or category associated with the security item. For example, the verification type may indicate a type of loan or application to be verified and/or audited (e.g., an auto loan, a personal loan, a mortgage, or another type of loan or application). The verification type may indicate the information to be verified (e.g., information to be audited for the account and/or the application). For example, the verification type may be associated with the one or more verification parameters.

In some implementations, the verification device may determine, based on the extracted information, available information to be verified for respective verification parameters. For example, the verification device may determine information, from the extracted information, that matches one or more verification parameters. For example, the verification device may extract relevant features from the extracted information. As an example, the verification device may apply a trained machine learning model to recognize a verification parameter associated with the extracted features. The machine learning model may be a rule-based system, a statistical model, and/or a machine learning algorithm, among other examples. The machine learning model may be trained on a labeled dataset containing examples of different verification parameters to learn the patterns and relationships between features and verification parameters. The verification device may match the extracted information with one or more requirements and constraints of a matched verification parameter. For example, the verification device may compare the extracted information against predefined rules and conditions associated with the verification parameter. For instance, if the verification parameter is a date, then the verification device may determine whether the extracted information conforms to a valid date format. This may conserve processing resources, computing resources, and/or network resources that would have otherwise been used to attempt to verify and/or audit extracted information that does not comply with rules and conditions associated with respective verification parameters (e.g., because a third-party device and/or data source may be unable to provide verification if the extracted information does not comply with rules and conditions).

For example, the verification device may determine that the information to be verified, from the extracted information, includes information that matches and/or is associated with a verification parameter and information that complies or conforms with rules and conditions associated with that verification parameter. In some implementations, the verification device may determine whether the information to be verified includes sufficient information to perform a verification operation and/or an auditing operation. For example, the verification event may indicate one or more primary verification parameters that are to be verified and/or audited to perform the verification operation and/or the auditing operation. If the information to be verified does not include information associated with the one or more primary verification parameters, then the verification device may determine that the verification operation and/or the auditing operation cannot be performed. If the information to be verified does include information associated with the one or more primary verification parameters, then the verification device may determine that the verification operation and/or the auditing operation can be performed. This may conserve processing resources, computing resources, and/or network resources that would have otherwise been used to attempt to verify and/or audit extracted information that does not include the minimum amount of information to successfully perform the verification operation and/or the auditing operation.

As shown by reference number 140, the verification device may determine, based on the information to be verified, one or more communication channels for respective data sources. For example, the verification device may determine one or more data sources to be used for the verification operation and/or the auditing operation. The one or more data sources may be based on the extracted information. For example, the verification device may determine, based on the extracted information and the one or more verification parameters, one or more data sources associated with the verification event.

For example, the verification device may determine, based on a verification type associated with the verification event, a set of data sources. For example, the set of data sources may be data sources that store and/or have access to relevant information for the verification type. For example, the verification device may store a mapping and/or database indicating an association between data sources and verification types. The verification device may determine, based on the extracted information and/or via a named entity recognition operation, one or more entities indicated by the one or more document images. For example, the extracted information and/or the information to be verified may indicate the one or more entities. The verification device may determine, based on the one or more entities, at least one data source, of the one or more data sources, from the set of data sources.

As an example, the extracted information may indicate a credit score. The verification device may determine one or more credit bureaus from which the credit score can be verified and/or audited. As another example, the extracted information may indicate an income. The verification device may determine, based on a source of the income (e.g., an employer), a data source from which the income can be verified. As another example, the extracted information may indicate personally identifiable information, such as a social security number. The verification device may determine one or more data sources from which personally identifiable information can be verified, such as a credit bureau, a government entity data source, or another data source.

The verification device may determine, for each data source determined or identified by the verification device, one or more communication channels over which the verification device can communicate with that data source. For example, the extracted information may indicate an entity name and/or a data source. The verification device may determine, based on the entity name and/or the data source, one or more communication channels. The one or more communication channels may include an API channel, a web service channel (e.g., a Hypertext Transfer Protocol (HTTP) channel), a message queue channel, a remote procedure call channel, a file transfer protocol channel, a peer-to-peer channel, an inter-process communication channel, and/or another communication channel. For example, the verification device may determine, for a data source of the one or more data sources, an API endpoint and/or an API address associated with the data source based on the extracted information.

For example, the extracted information may indicate an entity name and/or a data source. The verification device may determine, based on the entity name and/or the data source, one or more communication channels. For example, the verification device may identify or determine, from the extracted information, an indication of one or more funding sources associated with the account. The verification device may determine, based on the one or more funding sources, one or more communication channels to communicate with a data source associated with the one or more funding sources. For example, the data source may be associated with an employer. As another example, the data source may be a data source that stores publicly available information (e.g., that may indicate a known employer of the user associated with the account). As another example, the data source may be a credit bureau (e.g., that stores reported and/or known information associated with the user). The communication channel may be an API associated with, or provided by, the credit bureau.

As shown in FIG. 1C, and by reference number 145, the verification device may transmit one or more requests to verify extracted information to the one or more data sources. For example, the verification device may transmit requests via respective communication channels to verify extracted information associated with the one or more verification parameters. The requests may be transmitted via API calls or other communication types. As shown by reference number 150, the verification device may receive, via communication channels of respective data sources, one or more verification responses. The one or more verification responses may indicate verification information. The verification information may indicate whether the extracted information is verified and/or authentic.

For example, the verification device may communicate, with the one or more data sources, to obtain the verification information that is based on the extracted information. As an example, the verification information may indicate information stored by respective data sources associated with the user that is associated with the account. For example, for a data source associated with a given verification parameter, a request to the data source may indicate information identifying the user and a request for the verification parameter for the user. For example, if the verification parameter is a date of birth, the request may indicate information identifying the user (e.g., a name and/or a social security number) and a request to indicate the date of birth of the user.

In some implementations, the request(s) may indicate a request for the data needed to complete a verification and/or audit associated with the account and/or application. For example, the request(s) may indicate information identifying the user and the one or more verification parameters to enable the verification device to obtain the verification information. For example, the verification information may indicate information stored and/or obtained by respective data sources for the one or more verification parameters. As an example, the verification information may indicate available information associated with the user that is relevant to the one or more verification parameters.

As an example, a verification parameter may be one or more funding sources that are associated with the account, such as an income source and/or an employment source. The verification device may transmit, via the one or more communication channels, a request to verify that the one or more funding sources are associated with the account. For example, the request may indicate information identifying the user and a request to indicate any funding sources associated with the user. The verification device may receive, via the one or more communication channels, an indication of whether the one or more funding sources are associated with the account. For example, the verification response may indicate any known funding sources (e.g., income sources and/or employment sources) associated with the user.

In some implementations, the verification device may determine one or more secondary data sources associated with a given verification parameter. For example, the verification device may transmit, via a first communication channel associated with a first data source, a first request to verify information indicated by the extracted information. The verification device may detect, based on transmitting the first request, an error associated with the first request. The verification device may determine, based on the extracted information and the one or more verification parameters, a secondary data source associated with verifying the information. The verification device may transmit, via a second communication channel associated with the secondary data source, a second request to verify the information.

As shown by reference number 155, the verification device may determine, based on the one or more verification responses, feedback information for the account and/or the application. For example, the verification device may determine, based on the verification information and the one or more verification parameters, feedback information associated with the account. The feedback information may indicate whether any discrepancies exist associated with the one or more document images. For example, the verification device may determine whether the verification information indicates that one or more parameters indicated by the extracted information are verified.

As an example, for a given verification parameter, the verification device may compare the extracted information for the given verification parameter to verification information (e.g., indicated by one or more data sources) for the given verification parameter. If the information, for a given verification parameter, that is extracted from the one or more document images matches or is verified by the verification information, then the verification device may determine that there is not a discrepancy for the given verification parameter. If the information, for a given verification parameter, that is extracted from the one or more document images does not match or is not verified by the verification information, then the verification device may determine that there is a discrepancy for the given verification parameter.

As an example, the given verification parameter may be a social security number. The verification device may compare a social security number extracted from the one or more document images to a social security number indicated by a verification response. If the social security numbers match, then the verification device may determine that there is not a social security number discrepancy. If the social security numbers do not match, then the verification device may determine that there is a social security number discrepancy.

In some implementations, based on one or more detected discrepancies, the verification device may determine whether a process or operation associated with the account (e.g., with the loan) was correctly performed. For example, the feedback information may indicate whether there are any discrepancies on how a particular task is performed. As an example, the verification device may determine one or more expected documents based on information associated with the account (e.g., based on a type of account or loan). The verification device may determine whether the document(s) indicated by the one or more document images include the one or more expected documents. If the document(s) indicated by the one or more document images do not include at least one of the one or more expected documents (or if the document(s) indicated by the one or more document images include incorrect or irrelevant documents), then the verification device may determine that a process associated with collecting the documents was not correctly performed (e.g., and may indicate this via the feedback information).

Additionally, or alternatively, the verification device may determine expected information based on information associated with the account (e.g., based on a type of account or loan). The verification device may determine whether the document(s) indicated by the one or more document images include the expected information. If the document(s) indicated by the one or more document images do not include at least a portion of the expected information, then the verification device may determine that a process associated with collecting the information was not correctly performed (e.g., and may indicate this via the feedback information). As another example, the one or more document images may include information associated with one or more tasks performed by an employee associated with an application, such as one or more verification tasks associated with verifying information provided by an applicant. The verification device may analyze information associated with the one or more tasks to determine whether the one or more tasks were correctly performed (e.g., and may indicate this via the feedback information).

In some implementations, based on one or more detected discrepancies, the verification device may perform one or more fraud detection operations. For example, based on detecting a discrepancy, the verification device may perform the one or more fraud detection operations. In some implementations, the verification device may perform the one or more fraud detection operations based on a quantity of discrepancies satisfying a fraud threshold. Additionally, or alternatively, the verification device may perform the one or more fraud detection operations based on detecting a discrepancy associated with a verification parameter that is indicative of fraud, such as a social security number, an address, and/or a funding source, among other examples.

The one or more fraud detection operations may include providing the extracted information to a fraud model that is trained to output a fraud score that is indicative of a likelihood that the account and/or the application is associated with fraud. The verification device may obtain an indication of the fraud score. If the fraud score satisfies a threshold, then the verification device may determine that the account and/or the application is associated with fraud.

Additionally, or alternatively, the one or more fraud detection operations may include transmitting, via a communication channel associated with the user and/or an entity associated with the account or application, a request to confirm the extracted information. For example, the one or more verification responses may indicate contact information associated with the user, such as a phone number, address, and/or email address, among other examples. The verification device may transmit, via a communication channel indicated by the contact information, a request to verify that the user initiated the account and/or the application (e.g., the verification device may cause a phone call or text message to be sent to the known phone number (indicated by a verification response) associated with the user). As another example, the verification device may transmit, via a communication channel associated with a location or entity at which the one or more document images were obtained (e.g., a branch or location of the entity or institution providing or managing the account or the application), a request to verify that the user initiated the account and/or the application. This may enable the verification device to identify fraudulent activity before a loan application is approved, thereby conserving processing resources, computing resources, and/or network resources that would have otherwise been used to identify, correct, and/or remedy the fraudulent activity.

As shown in FIG. 1D, and by reference number 160, the verification device may transmit, to the data streaming platform, the feedback information. As shown by reference number 165, the data streaming platform may transmit, and the client device may receive, an indication of the feedback information. For example, the verification device may transmit, via the data streaming platform and based on obtaining the one or more document images, the feedback information. For example, the verification device may transmit the feedback information via a topic associated with providing feedback information. The client device may subscribe to the topic. As a result, the client device may obtain the feedback information, via the data streaming platform, based on an asynchronous event occurring, such as the verification device transmitting the feedback information to the data streaming platform. The feedback information may indicate whether one or more tasks associated with an application (e.g., for a loan) were correctly or successfully performed.

As shown by reference number 170, the client device may perform an action based on the feedback information. For example, the feedback information may indicate whether there are any discrepancies with the documents obtained by the client device. In some implementations, the action may include providing, for display, an indication of the feedback information (e.g., an indication of whether there are any discrepancies). Additionally, or alternatively, the action may include approving or denying the application associated with the account. For example, if the feedback information indicates one or more discrepancies, then the client device may deny the application associated with the account. If the feedback information indicates that there are no discrepancies, then the client device may approve the application associated with the account. This may conserve processing resources, computing resources, and/or network resources that would have otherwise been used to identify one or more discrepancies after approving the application (e.g., after funding a loan), determining action(s) to remedy or investigate the one or more discrepancies, and performing the action(s), among other examples.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a verification device 210, a data streaming platform 220, a client device 230, one or more data sources 240, and a network 250. Devices of environment 200 may interconnect via wired connections, wireless connections, or a combination of wired and wireless connections.

The verification device 210 may include one or more devices capable of receiving, generating, storing, processing, providing, and/or routing information associated with document analysis and extraction for verification events, as described elsewhere herein. The verification device 210 may include a communication device and/or a computing device. For example, the verification device 210 may include a server, such as an application server, a client server, a web server, a database server, a host server, a proxy server, a virtual server (e.g., executing on computing hardware), or a server in a cloud computing system. In some implementations, the verification device 210 may include computing hardware used in a cloud computing environment.

The data streaming platform 220 may include one or more devices capable of receiving, generating, storing, processing, providing, and/or routing information associated with document analysis and extraction for verification events, as described elsewhere herein. The data streaming platform 220 may include a communication device and/or a computing device. For example, the data streaming platform 220 may include a server, such as an application server, a client server, a web server, a database server, a host server, a proxy server, a virtual server (e.g., executing on computing hardware), or a server in a cloud computing system. In some implementations, the data streaming platform 220 may include computing hardware used in a cloud computing environment.

The data streaming platform 220 may be a distributed event streaming system that provides a unified framework for managing the flow of data, allowing data producers (e.g., the client device 230) to publish events, and data consumers (e.g., the verification device 210) to subscribe to and process these events. In some implementations, the data streaming platform 220 may include computing hardware, a resource management component, a host operating system (OS), and/or one or more virtual computing systems. The data streaming platform may execute on, for example, an AMAZON WEB SERVICES platform, a MICROSOFT AZURE platform, or a SNOWFLAKE platform. The resource management component may perform virtualization (e.g., abstraction) of computing hardware to create the one or more virtual computing systems. Using virtualization, the resource management component enables a single computing device (e.g., a computer or a server) to operate like multiple computing devices, such as by creating multiple isolated virtual computing systems from computing hardware of the single computing device. In this way, computing hardware can operate more efficiently, with lower power consumption, higher reliability, higher availability, higher utilization, greater flexibility, and lower cost than using separate computing devices. The data streaming platform 220 may include a serverless function. The serverless function may be referred to as an anonymous function and/or a lambda function, among other examples. The serverless function may include code that executes in a cloud computing environment and that is executed in response to a specific trigger or event. The serverless function may enable a provider associated with the cloud computing environment to provision infrastructure and/or resources (e.g., computing hardware, one or more virtual computing systems, one or more processors, one or more memories, one or more networking components, one or more virtual machines, one or more containers, and/or one or more hybrid environments) in response to tasks and/or requests to be performed in the cloud computing environment. For example, the serverless function may enable the provider to abstract away the underlying infrastructure and to handle the management, maintenance and/or scaling of resources for executing user-defined functions associated with the serverless function,

The client device 230 may include one or more devices capable of receiving, generating, storing, processing, and/or providing information associated with document analysis and extraction for verification events, as described elsewhere herein. The client device 230 may include a communication device and/or a computing device. For example, the client device 230 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The data source 240 may include one or more devices capable of receiving, generating, storing, processing, and/or providing information associated with document analysis and extraction for verification events, as described elsewhere herein. The data source 240 may include a communication device and/or a computing device. For example, the data source 240 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 240 may communicate with one or more other devices of environment 200, as described elsewhere herein.

The network 250 may include one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with document analysis and extraction for verification events. The device 300 may correspond to the verification device 210, the data streaming platform 220, the client device 230, and/or a data source 240. In some implementations, the data streaming platform 220, the client device 230, and/or a data source 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

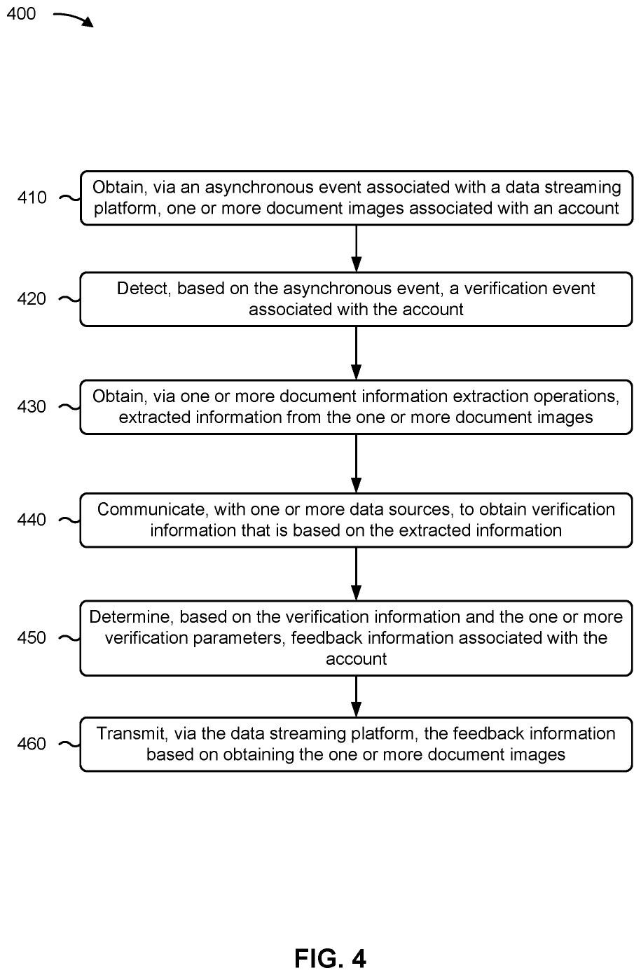

FIG. 4 is a flowchart of an example process 400 associated with document analysis and extraction for verification events. In some implementations, one or more process blocks of FIG. 4 may be performed by the verification device 210. In some implementations, one or more process blocks of FIG. 4 may be performed by another device or a group of devices separate from or including the verification device 210, such as the data streaming platform 220, the client device 230, and/or one or more data sources 240. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining, via an asynchronous event associated with a data streaming platform, one or more document images associated with an account (block 410). For example, the verification device 210 (e.g., using processor 320 and/or memory 330) may obtain, via an asynchronous event associated with a data streaming platform, one or more document images associated with an account, as described above in connection with reference number 120 of FIG. 1A. As an example, the one or more document images may be images of documents associated with an application that is associated with the account.

As further shown in FIG. 4, process 400 may include detecting, based on the asynchronous event, a verification event associated with the account (block 420). For example, the verification device 210 (e.g., using processor 320 and/or memory 330) may detect, based on the asynchronous event, a verification event associated with the account, as described above in connection with reference number 130 of FIG. 1B. In some implementations, the verification event is associated with one or more verification parameters. As an example, the one or more verification parameters may indicate information to be verified and/or audited for the application.

As further shown in FIG. 4, process 400 may include obtaining, via one or more document information extraction operations, extracted information from the one or more document images (block 430). For example, the verification device 210 (e.g., using processor 320 and/or memory 330) may obtain, via one or more document information extraction operations, extracted information from the one or more document images, as described above in connection with reference number 125 of FIG. 1A. As an example, the verification device 210 may extract information from the one or more document images and analyze the information to identify the extracted information.

As further shown in FIG. 4, process 400 may include communicating, with one or more data sources, to obtain verification information that is based on the extracted information (block 440). For example, the verification device 210 (e.g., using processor 320 and/or memory 330) may communicate, with one or more data sources, to obtain verification information that is based on the extracted information, as described above in connection with reference number 145 and/or reference number 150 of FIG. 1C. In some implementations, the one or more data sources are based on the extracted information. As an example, the verification device 210 may determine one or more communication channels associated with respective data sources of the one or more data sources. The verification device 210 may communicate over the one or more communication channels to obtain the verification information. The verification information may indicate known or stored information associated with a user indicated by the application.

As further shown in FIG. 4, process 400 may include determining, based on the verification information and the one or more verification parameters, feedback information associated with the account, wherein the feedback information indicates whether any discrepancies exist associated with the one or more document images (block 450). For example, the verification device 210 (e.g., using processor 320 and/or memory 330) may determine, based on the verification information and the one or more verification parameters, feedback information associated with the account, as described above in connection with reference number 155 of FIG. 1C. In some implementations, the feedback information indicates whether any discrepancies exist associated with the one or more document images. As an example, the verification device 210 may compare the extracted information to the verification information for the one or more verification parameters.

As further shown in FIG. 4, process 400 may include transmitting, via the data streaming platform, the feedback information based on obtaining the one or more document images (block 460). For example, the verification device 210 (e.g., using processor 320, memory 330, and/or communication component 360) may transmit, via the data streaming platform, the feedback information based on obtaining the one or more document images, as described above in connection with reference number 160 of FIG. 1D. As an example, the verification device 210 may transmit an indication of whether any discrepancies are detected in association with the application.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for document analysis and extraction for verification events, the system comprising:
one or more memories; and
one or more processors, communicatively coupled to the one or more memories, configured to:
obtain, via an asynchronous event associated with a data streaming platform, one or more document images associated with an account;
detect, based on the asynchronous event, a verification event associated with the account, wherein the verification event is associated with one or more verification parameters;
obtain, via one or more document information extraction operations, extracted information from the one or more document images;
determine, based on the extracted information and the one or more verification parameters, one or more data sources associated with the verification event;
communicate, with the one or more data sources, to obtain verification information that is based on the extracted information;
determine, based on the verification information and the one or more verification parameters, feedback information associated with the account, wherein the feedback information indicates whether any discrepancies exist associated with the one or more document images; and
transmit, via the data streaming platform and based on obtaining the one or more document images, the feedback information.

2. The system of claim 1, wherein the one or more document information extraction operations include at least one of:
an optical character recognition operation,
a natural language processing operation,
a named entity recognition operation, or
a text mining operation.

3. The system of claim 1, wherein the one or more processors, to determine the one or more data sources, are configured to:
determine, for a data source of the one or more data sources, an application programming interface (API) endpoint associated with the data source based on the extracted information.

4. The system of claim 1, wherein the one or more processors, to obtain the extracted information, are configured to:
extract, via the one or more document information extraction operations, the one or more verification parameters,
wherein the one or more verification parameters include a requested amount parameter indicated by a document depicted by the one or more document images.

5. The system of claim 4, wherein the one or more processors, to determine the one or more data sources, are configured to:
identify, from the extracted information, an indication of one or more funding sources associated with the account; and
determine, based on the one or more funding sources, one or more communication channels to communicate with a data source associated with the one or more funding sources; and
wherein the one or more processors, to determine the feedback information, are configured to:
transmit, via the one or more communication channels, a request to verify that the one or more funding sources are associated with the account; and
receive, via the one or more communication channels, an indication of whether the one or more funding sources are associated with the account,
wherein the feedback information indicates whether the one or more funding sources are associated with the account.

6. The system of claim 1, wherein the data streaming platform includes a serverless function associated with a cloud computing environment.

7. The system of claim 1, wherein the one or more processors, to determine the one or more data sources, are configured to:
determine, based on the extracted information, a verification type associated with the account;
determine, based on the verification type, a set of data sources;
determine, based on the extracted information and via a named entity recognition operation, one or more entities indicated by the one or more document images; and
determine, based on the one or more entities, at least one data source, of the one or more data sources, from the set of data sources.

8. A method for document analysis and extraction for verification events, comprising:
obtaining, by a device and via an asynchronous event associated with a data streaming platform, one or more document images associated with an account;
detecting, by the device and based on the asynchronous event, a verification event associated with the account, wherein the verification event is associated with one or more verification parameters;
obtaining, by the device and via one or more document information extraction operations, extracted information from the one or more document images;
communicating, by the device and with one or more data sources, to obtain verification information that is based on the extracted information,
wherein the one or more data sources are based on the extracted information;
determining, by the device and based on the verification information and the one or more verification parameters, feedback information associated with the account, wherein the feedback information indicates whether any discrepancies exist associated with the one or more document images; and
transmitting, by the device and via the data streaming platform, the feedback information based on obtaining the one or more document images.

9. The method of claim 8, further comprising:
determining, based on the extracted information and the one or more verification parameters, one or more communication channels associated with respective data sources from the one or more data sources.

10. The method of claim 9, wherein the one or more communication channels are associated with respective application programming interface (API) endpoints.

11. The method of claim 8, wherein communicating to obtain the verification information comprises:
transmitting, via a first communication channel associated with a first data source, a first request to verify information indicated by the extracted information;
detecting, based on transmitting the first request, an error associated with the first request;
determining, based on the extracted information and the one or more verification parameters, a secondary data source associated with verifying the information; and
transmitting, via a second communication channel associated with the secondary data source, a second request to verify the information.

12. The method of claim 8, wherein determining the feedback information comprises:
determining whether the verification information indicates that one or more parameters indicated by the extracted information are verified.

13. The method of claim 8, wherein the one or more document information extraction operations include at least one of:
an optical character recognition operation, or
a natural language processing operation.

14. The method of claim 8, wherein obtaining the extracted information comprises:
extracting, via the one or more document information extraction operations, the one or more verification parameters,
wherein the one or more verification parameters include a requested amount parameter indicated by a document depicted by the one or more document images.

15. The method of claim 11, wherein determining the one or more data sources comprises:
identifying, from the extracted information, an indication of one or more funding sources associated with the account; and
determining, based on the one or more funding sources, one or more communication channels to communicate with a data source associated with the one or more funding sources; and
wherein determining the feedback information comprises:
transmitting, via the one or more communication channels, a request to verify that the one or more funding sources are associated with the account; and
receiving, via the one or more communication channels, an indication of whether the one or more funding sources are associated with the account,
wherein the feedback information indicates whether the one or more funding sources are associated with the account.

16. The method of claim 8, wherein determining the one or more data sources comprises:
determining, based on the extracted information, a verification type associated with the account;
determining, based on the verification type, a set of data sources;
determining, based on the extracted information and via a named entity recognition operation, one or more entities indicated by the one or more document images; and
determining, based on the one or more entities, at least one data source, of the one or more data sources, from the set of data sources.

17. A non-transitory computer-readable medium storing a set of instructions, the set of instructions comprising:
one or more instructions that, when executed by one or more processors of a device, cause the device to:
obtain, via an asynchronous event associated with a serverless function, one or more document images associated with an account;
detect, based on the asynchronous event, a verification event associated with the account, wherein the verification event is associated with one or more verification parameters;
obtain, via one or more document information extraction operations, extracted information from the one or more document images;
determine, based on the extracted information and the one or more verification parameters, one or more data sources associated with the verification event;
communicate, with the one or more data sources, to obtain verification information that is based on the extracted information;
determine, based on the verification information and the one or more verification parameters, feedback information associated with the account, wherein the feedback information indicates whether any discrepancies exist associated with the one or more document images; and
transmit, based on obtaining the one or more document images, the feedback information.

18. The non-transitory computer-readable medium of claim 17, wherein the one or more instructions, that cause the device to determine the one or more data sources, cause the device to:
determine, for a data source of the one or more data sources, an application programming interface (API) endpoint associated with the data source based on the extracted information.

19. The non-transitory computer-readable medium of claim 17, wherein the one or more instructions, that cause the device to obtain the extracted information, cause the device to:
extract, via the one or more document information extraction operations, the one or more verification parameters,
wherein the one or more verification parameters include a requested amount parameter indicated by a document depicted by the one or more document images.

20. The non-transitory computer-readable medium of claim 17, wherein the one or more instructions, that cause the device to determine the one or more data sources, cause the device to:
determine, based on the extracted information, a verification type associated with the account;
determine, based on the verification type, a set of data sources;
determine, based on the extracted information and via a named entity recognition operation, one or more entities indicated by the one or more document images; and
determine, based on the one or more entities, at least one data source, of the one or more data sources, from the set of data sources.
